(19) United States
(12) Patent Application Publication
(10) Pub. No.: US 2007/0209439 A1
(43) Pub. Date: Sep. 13, 2007

(54) APPARATUS AND METHOD FOR DETECTION OF PLASTIC MATERIALS

(76) Inventor: Ronald L. Helms, Vienna, VA (US)

Correspondence Address: ORZECHOWSKI & BARRY, LLC, P.O. BOX 232, KENSINGTON, MD, 20895-0232, US

(21) Appl. No.: 11/573,888

(22) PCT Filed: Aug. 16, 2005
(86) PCT No.: PCT/US05/29082

§ 371 Date: Feb. 16, 2007

Related U.S. Application Data
(60) Provisional application No. 60/601,855, filed on Aug. 16, 2004.

(51) Int. Cl. G01N 27/00

(52) U.S. Cl. 73/579

(57) ABSTRACT

A plastic detection apparatus and method capable of determining the presence of plastic materials as well as the type, amount and/or location of the plastic material.

### FIELD OF THE INVENTION

The present invention relates to an apparatus and method for the detection of plastic materials, particularly concealed plastic materials such as plastic explosives, plastic weapons, and the like. The present invention further relates to a plastic detection apparatus and method capable of determining the type, amount, and/or location of the plastic material present.

### BACKGROUND OF THE INVENTION

Reliable detection of concealed materials such as weapons, explosives and the like is a critical issue in providing security to both military personnel and the general population. Such detection is a first line of defense against terrorist attacks.

Furthermore, there is a need for such detection systems that are capable of use on a relatively rapid basis, preferably in real time, so as to allow scanning of individuals trucks and the like.

Traditional inspection systems, such as X-ray imaging systems and metal detectors, based on electromagnetic induction, have been used to detect guns, knives and other weapons as well as explosive materials such as C4. These inspection systems, although capable of near real-time detection, have limitations and adverse effects in the detection of concealed targets. Limitations of metal detectors include the inabilities to (a) provide precise target location, (b) detect plastic concealed weapons, and (c) detect certain metals because of sensitivity variation for various metals. Limitations of X-ray imaging of personnel include radiological health effects.

Additionally, increasingly sophisticated weapons have been developed such as plastic and carbon fiber based weapons that are invisible to or undetectable by such conventional inspection systems. Furthermore, these systems are subject to false positive reading such as where metal detectors provide no differentiation between benign metallic objects and ordinance containing explosive material

Accordingly, there is a continuing need for a device and method for detecting plastic materials and objects containing plastic materials.

There is a further need for such detection systems that can be concealed so that only the person conducting the scanning is aware of the system.

### SUMMARY OF THE INVENTION

It is an object of the present invention to provide an apparatus and method for detecting and pinpointing the location and amount of plastic materials, particularly concealed plastic materials such as plastic explosives, plastic arms and knives, and the like.

It is a further object of the present invention to provide a plastic detection apparatus and method capable of determining and evaluating the type, amount and/or location of the plastic material; present.

It is a further object of the present invention to provide a plastic detection method and apparatus for determining the amount of plastic present and its location.

It is still further object of the present invention to provide a plastic detection method and apparatus that determines the amount and location of any plastic present by simultaneously or sequentially monitoring a broad spectrum of sequential frequencies and processing the signals so monitored to produce data showing the amount and location of any plastic present.

Preferably, the measurement of the frequencies of interest is made using a non-directional antenna, a high-impedance input broadband receiver (e.g., 1 to 50,000 HZ), followed by an anti-alias filter feeding into an analog to digital converter. Through appropriate computer software, the broadband signal is processed and in a preferred embodiment is connected to a monitoring or alarm system that indicates when plastic is present and in a more preferred embodiment, the amount and/or location of the plastic. In another embodiment, the data from the processed broadband signal can be stored, for example on a computer disk, for archival purposes or for further processing and access.

The method and apparatus of the present invention permits real time monitoring and detecting of plastic materials so that the presence and/or absence of the same can be observed in real time.

The method and apparatus can be sued in lieu of or in conjunction with conventional inspection techniques such as metal detectors, X-rays, microwaves, and the like. The method and apparatus can also be used to quickly eliminate false positive readings from such conventional detectors to thus allow faster processing and throughput. In the airline screening process, this would allow a more targeted hand searching of travelers, thus providing a greater margin of safety in a much more time and cost effective manner without raising the ire of the fare-paying travelers. This method and apparatus can also be used to quickly screen shipments to target those that may warrant further screening or searching.

The present invention permits the user to obtain, by passive measurements, an image of where plastic materials are located similar to that obtained within a human body by a CAT Scan or a Nuclear Magnetic Resonance (NMR) Scan.

Additional objects, advantages, and novel features of the invention will be set forth in pair in the description which follows, and in part will become apparent to those skilled in the art upon examination of the following or will be learned by practice of the invention. The objects and advantages of the invention may be realized and attained by means of the instrumentalities and combinations particularly pointed out in the appended claims.

### BRIEF DESCRIPTION OF THE DRAWING FIGURES

The accompanying drawings, which are incorporated in and form a part of the specification, illustrate various embodiments of the present invention and, together with the description, serve to explain the principles of the invention. In the drawings:

FIG. 1 is a schematic view of a first embodiment of a mobile plastic detector of the present invention in the forms of a wanding device;

FIG. 2 is a schematic view of a second embodiment of a stationary plastic detector of the present invention in the form of a scanning unit;

FIG. 3 is a schematic block diagram of one embodiment of a detector according to the present invention;

FIG. 4 is a graph depicting the filtering characteristic of the anti-alias filter of FIG. 3;

FIG. 5 is another graph depicting the filtering characteristic of the anti-alias filter of FIG. 3;

FIG. 6 shows the data acquisition apparatus, object tested, and graph depicting results;

FIG. 7 shows the data acquisition apparatus, object tested, and graph depicting results;

FIG. 8 shows various objects tested;

FIG. 9 shows an antenna and amplifier suitable for use with the invention;

FIGS. 10, 11 and 12 show the results of various experiments.

### DETAILED DESCRIPTION OF THE INVENTION

The present invention is directed to the unexpected discovery that the presence, location and/or amount of plastic materials can be detected using the apparatus of the present invention. The apparatus of the present invention is based upon the devices in my prior U.S. Pat. Nos. 4,507,611 for Method for Detecting Surface and Subsurface Anomalies of the Earth Using Vertical Current Measurements, 4,825,165 for Method and Apparatus for Detecting a Tansient Phenomenon by Monitoring Variations of an Alternating Component of a Vertical Current Emanating From the Earth's Surface, and 5,148,110 for Method and Apparatus for Passively Detecting the Depth and Location of a Spatial or Temporal Anomaly by Monitoring a Time Varying Signal Emanating From the Earth's Surface, all of which are hereby incorporated by reference.

The apparatus of the present invention may take the form of a mobile unit, such as a scanning wand, to be scanned over a target such as a person, a piece of luggage or a shipping container. Alternatively, the apparatus of the present invention can take the form of a stationary unit through which the target is conveyed, such as in conventional x-ray screening devices of MRI devices.

It has now been discovered that the introduction of a plastic material into a field can modulate specific frequencies of that field, thus enabling detection of the presence of a plastic material in the field being measured, and can also detect the location, amount, and type of plastic materials present. In one embodiment of the invention, the plastic material is detected through a passive system in which the field being measured is a natural field created by the generally vertical current leakage from within the earth into the atmosphere as described in my prior patents. In other embodiments of the invention, the plastic material is detected through an active system in which the field is a man-made field that is created by other means known to those skilled in the arts and is preferably selected to enhance the detection of the plastic materials.

The frequency, amplitude and resonance frequency modulation of the weak, low-noise signal provides data which, when properly interpreted, may be used to obtain information regarding the presence of plastic materials, as well as the location, amount and type of the plastic materials.

The present invention can best be understood by reference to the accompanying drawings in which the elements of the apparatus of the present invention may be determined.

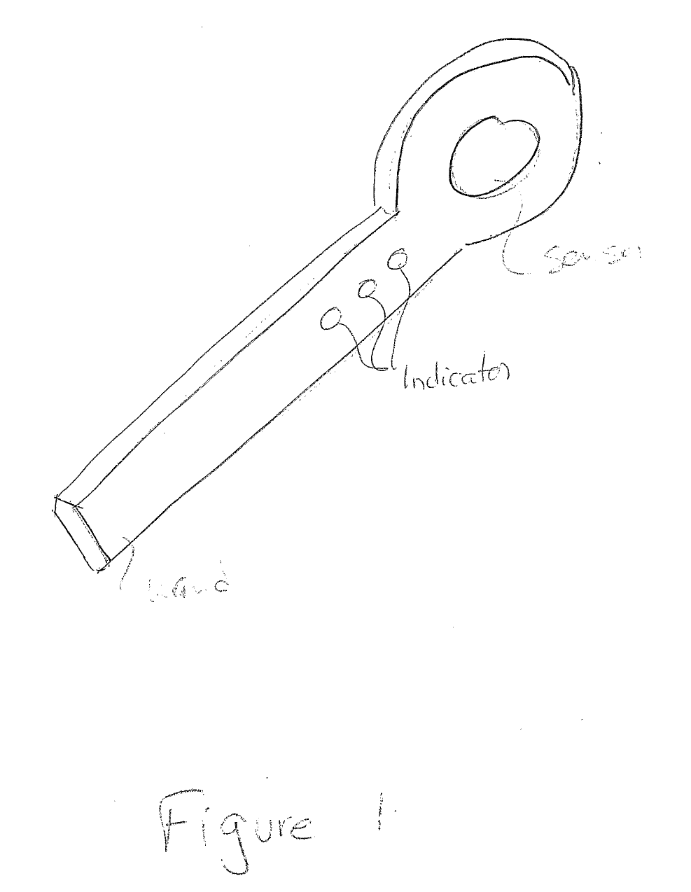

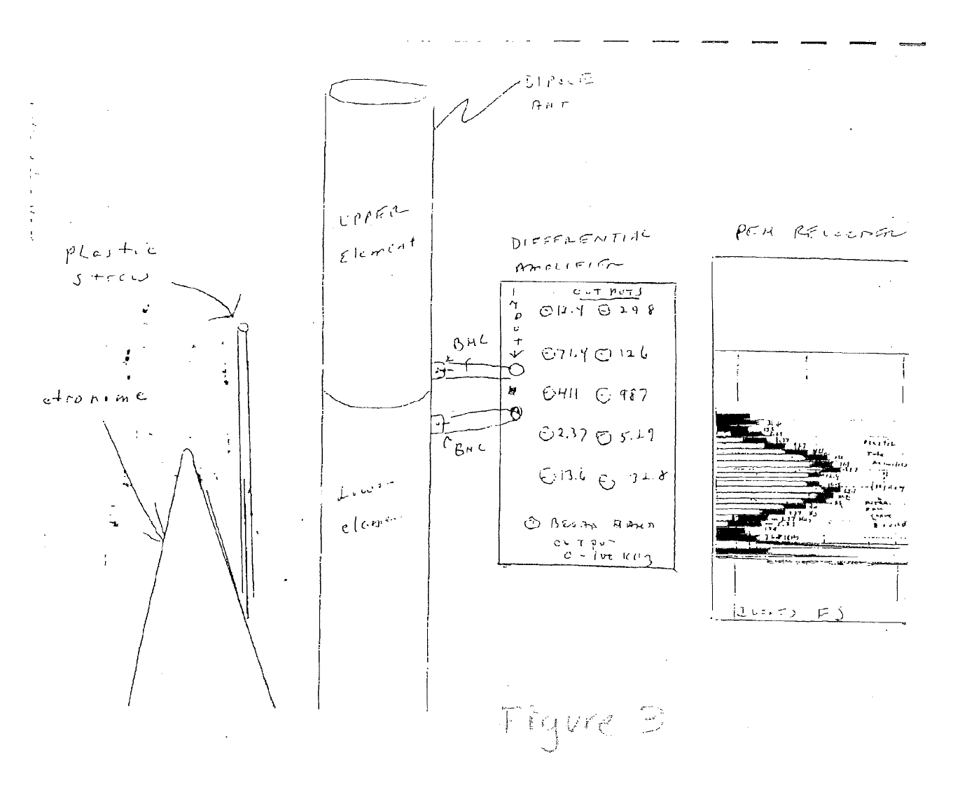

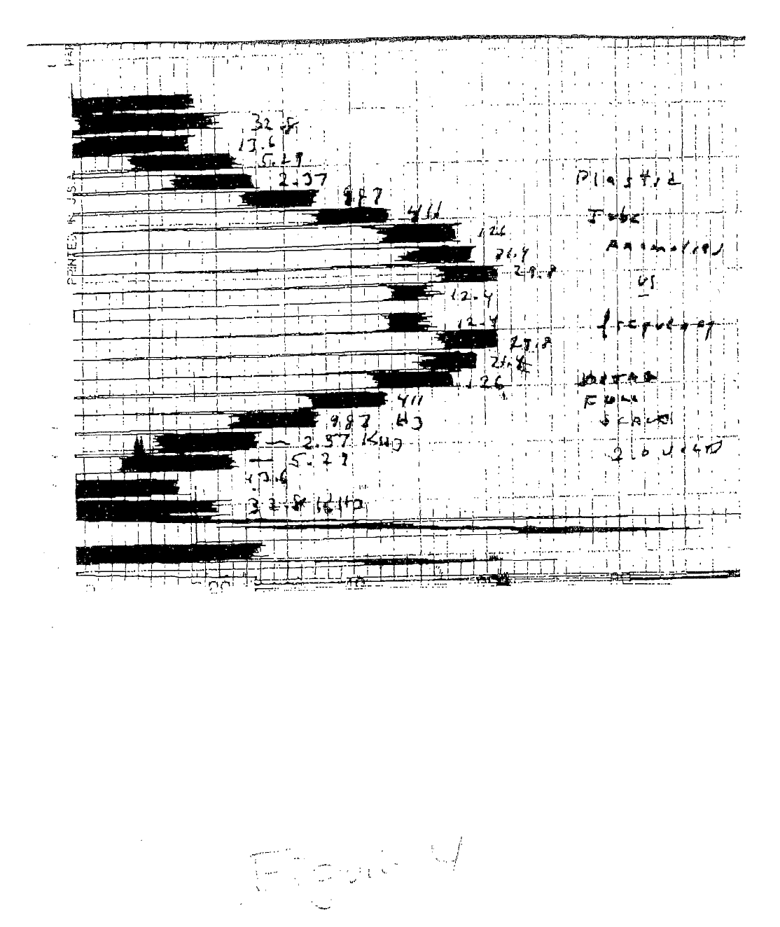

FIG. 1 shows a mobile screening device 10 in the form of a wand with a handle portion 11 and a detection head 12 is shown. The detection head 12 contains indicator means 13 that shows the presence and amount of plastic detected. The detection head 12 contains a detector means 14 such as shown in FIGS. 3-6 that act to sense the change in the field due to the presence of the plastic material and then displays this on the indicator means 13. The indicator means 13 can be any suitable means known to one skilled in the art such as lights, a noise emitter, and the like, as well as combinations thereof.

In use, the user holds the handle portion 11 and moves the detection head 12 over the targeted area. The activation of the indicator means 13 correlates to the presence of a plastic material. The strength of the indicator means 13, i.e. such as multiple lights or increased volume or frequency of noise emitting, can be used to indicate the amount and/or type of plastic material present. The location of the plastic material can be determined by noting where the indicator means 13 is activated.

In further embodiments of the invention, the indicator means 13 may be located remotely from the wand 10 and may comprise a recorder means or the like. In a further embodiment, the modulated signals detected by the detection head 12 are sent to a remote means where the signals are processed and correlated to the presence of plastic materials as well as the type, location and amount thereof. In a further embodiment, in the presence of a plastic material, a signal is sent back to the indicator means 13 on the detection head 12 thus providing an alarm or other indication to the user of the device. In an alternative embodiment of the present invention, the signals are processed and recorded in such a way so that the target is unaware of the detection of the plastic material, thus allowing security forces to be aware of the presence and location of the plastic material prior to detention of the target. Furthermore, the results can be stored to provide evidence for court.

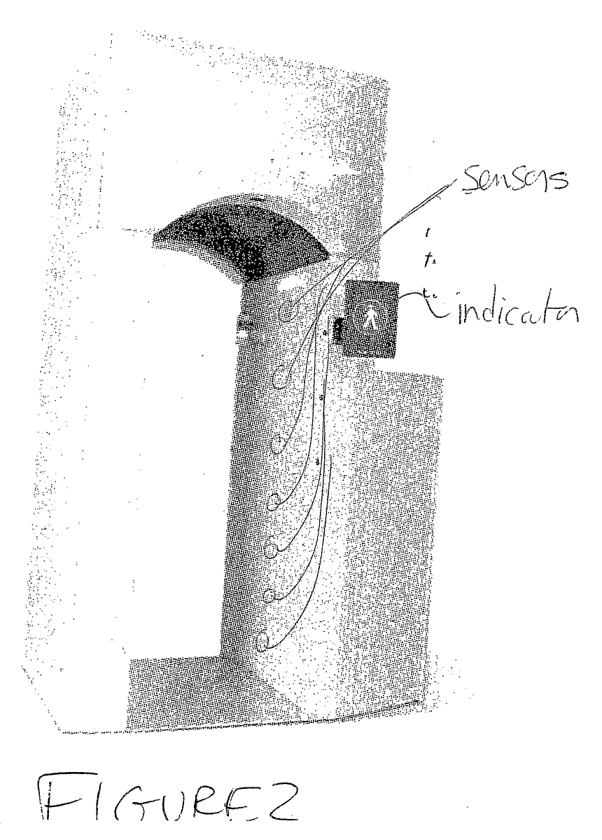

FIG. 2 depicts a stationary scanning unit 20 in which the target is placed for scanning. The stationary scanning unit 20 contains at least one detection head 21 containing a detection means 22 such as shown in FIGS. 3-6. In a preferred embodiment, multiple detection heads 21 are used in an array so as to enable a precise detection of the amount, location and type of any plastic materials present. The stationary scanning unit 20 may further comprise a display means 24, such as a computer screen, on which the results of the scan are displayed. In one embodiment, an image, such as shown by an X-ray machine, shows the location, type and amount of plastic material present. The stationary scanning unit 20 may comprise in lieu thereof or in addition thereto an indicator means 25 that provides a visual or audible signal as to the presence of plastic material. The indicator means may comprise any known to those skilled in the art such as indicator lights, meters, dials, and gauges, and noise emitting means.

Again, as with the mobile scanning unit 10, the stationary scanning unit 20 may be processed and recorded in such a way so that the target is unaware of the detection of the plastic material, thus allowing security forces to be aware of the detection of the plastic material, thus allowing security forces to be aware of the presence and location of the plastic material prior to detention of the target. Furthermore, the results can be stored to provide evidence for court.

In a further embodiment of the invention, a series of preprogrammed detection devices can be installed in peripheral rings around airports in conjunction with metal detectors and with explosive detectors and connected to a central processor to give advance warning or confirmation of weapons or explosive devices concealed in luggage or on a person or their effects.

The detection of the plastic material is based upon modulation or changes in the signal from a field which moves relative to the target.

The frequency data and frequency resonance modulation is preferably measured in a series of different frequency ranges, for example ranges a,b,c,d, . . . z. The overall anticipated frequency range preferably varies from less than 1 HZ to 100 KHZ but is preferably in the range of 1 HZ to 50 KHZ. Two types of frequency measurements can be direct or indirect. Direct frequency measurements generally relate to those which are natural in origin, i.e., magnetic, acoustic or radiation waveform electric currents emanating from the earth, and the total spectrum of such frequencies is in the range of from about 0 to 100 KHZ. Indirect frequency measurements relate to detection of data from man-made sources, such as AM, FM, TV, radar and the like, and extends across a range from about 1 KHZ to 100 MHZ or more.

The measurement of frequency data, either direct or indirect, gives the user information as to the presence of a plastic material, as well as to the type, amount and location thereof. In further embodiments of the invention, either direct, indirect, or a hybrid of the two can be sued to monitor and analyze data.

The frequency data, when properly analyzed, enables the user to determine, based on empirically determined relationships, the presence of plastic materials, the amount of such plastic materials, the type of such plastic materials, and the location of such plastic materials. Different types of plastic materials will produce higher or lower signal amplitudes and differing frequency modulations patterns. Higher or lower signal amplitude suggest differing electrical resistance characteristics, while the differing modulation patterns represent differing electrical velocity patterns, as well as differing resonance features. The differing resonance/velocities and amplitude characteristics enable one trained in the art to identify the type of plastic present, while the frequency at which a pattern is noted indicates the amount thereof.

FIG. 3 depicts an example of a presently preferred embodiment of detectors useful for practicing the present method is illustrated. FIG. 3 depicts the preferred system for acquiring and processing broad band AC signal data over a band pass of from about 0 HZ to 100 HZ, although a band pass of 0-10 KHZ is usually sufficient. The signals are received by an antenna 40 attached to a mobile scanning device 10 or a stationary scanning device 20, then amplified in amplifier 42 and filtered in filter 44, and passed, via an anti-alias filter 45, to an analog to digital (A/D) converter 46, and then fed into a CPU 48, preferably a portable PC compatible computer or equivalent, where the data is passed via an I/O device 49, to a recording medium, preferably in the form of a hard disk 50, a floppy disk 52, a tape 54, or the like. The stored data can be analyzed and processed as described below.

Through empirical experiments, one can determine within the nominal spectrum of frequencies of interest, i.e., on the order of 1 HZ through 50 KHZ, the frequency spectrum signature that each type of plastic material modulates. In other words, for each type of plastic material, electrical energy will be distributed in discrete frequency ranges along with discrete amplitude and modulation characteristics associated directly with those frequency patterns. Preferably, computer software is used to identify the frequency pattern unique to the particular plastic materials of interest.

Preferably, the input to the A/D converter 46 consists of the output of the antenna 40, conditioned by pre-amplifier 42, which is preferably a high input impedance amplifier in order to accurately measure the extremely small signals of interest. The filter 44 is preferably a 60 HZ notch filter. The filter 45 is preferably an anti-alias filter to prevent unwanted high-frequency signals from interfering with the band waves of interest. The analog-to-digital converter 46 can be any of several commercial boards, such as those available from Metra Byte or Lotus, which plug into a commercially available PC, workstation, mini-computer, or main-frame computer. The board converts the analog signal into a sequence of digital signals. Using computer software which comes with the board, the digital signals can then be stored in computer memory, for example, on the hard disk 50, or can be transmitted to the display means 24.

The anti-alias filter 45 is in the form of a low-pass filter having a filtering characteristic such as depicted in FIG. 2a. The filter 45 prevents higher frequency information from interfering with the accuracy of the frequency band being sampled. The filter should be selected so that the frequency f1 is set at the highest sampling frequency of interest. The frequency f2 should be set so that the filter roll off is as steep as practical. For example, if f1 were set at 10 KHZ, and a 72 db drop in the filter characteristic were desired, f2 should be selected to be about 20 KHZ.

A “file” on the hard disk containing this information can then be processed using commercially available, preferably menu driven software, such as “Asystant”, which produces printed output and which can process a wide variety of processing algorithms on data to generate many kinds of information, including a “frequency filter”. For a time series of data lasting, for example, 12 minutes, a sliding window one second long could be applied to the data, in which the time series is Fourier transformed, and power spectra generated at a variety of frequencies in the band between about 10 HZ and 10 KHZ. If 20 different frequencies are used, each a factor of about 1.4 greater than the one below, this would lead to frequencies of 10 HZ, 14 HZ, 19.6 HZ, 27.4 HZ, etc., up to 10 KHZ. A time series in each frequency band over the 12 minute time period of the data would be generated.

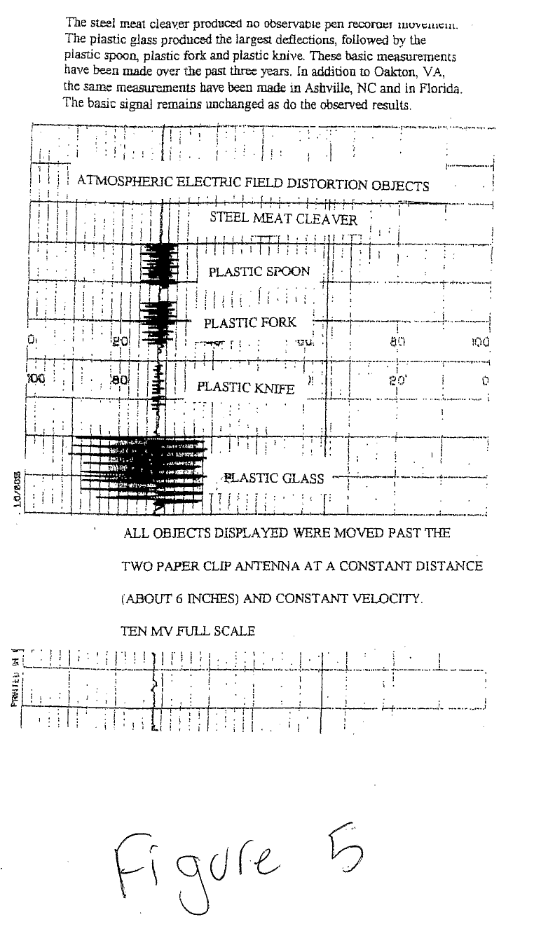

FIG. 5 is and illustration of a presently preferred embodiment of the invention. In FIGS. 3 and 5, similar devices are identified by similar reference numbers. In FIG. 5, the antenna 40 preferably comprises a spiral wound split helix forming a vertically oriented omni directional diepole. The antenna 40 feeds into a high impedance differential amplifier containing a 60 HZ notch filter. The output is directed to a broad band processor 30 (0-40 KHZ nominal) and then specific filters 32. Each of the filters 32 defines a frequency band of interest. The filtered signals are then passed via filter 45 to the A/D converter directly for depth measurement and/or through a rectifier 34 so that any dc level can be removed and then through an averaging circuit 36. The signals are then preferably passed through filter 45 and the A/D converter 46. The digitized signal is preferably transmitted to the display means 24 and or the indicator means. The digitized signal may also be stored on a hard disk or other storage media. The data is subsequently subjected to FFT spectral analysis in an analyzer 38 such as a Hewlett-Packard 3580A Spectrum Analyzer and displayed in two or three dimensions on display device 24 or transmitted to indicator means that react to the presence of plastic materials. This data acquisition and processing system can produce near photographic quality images of plastic material present in the target.

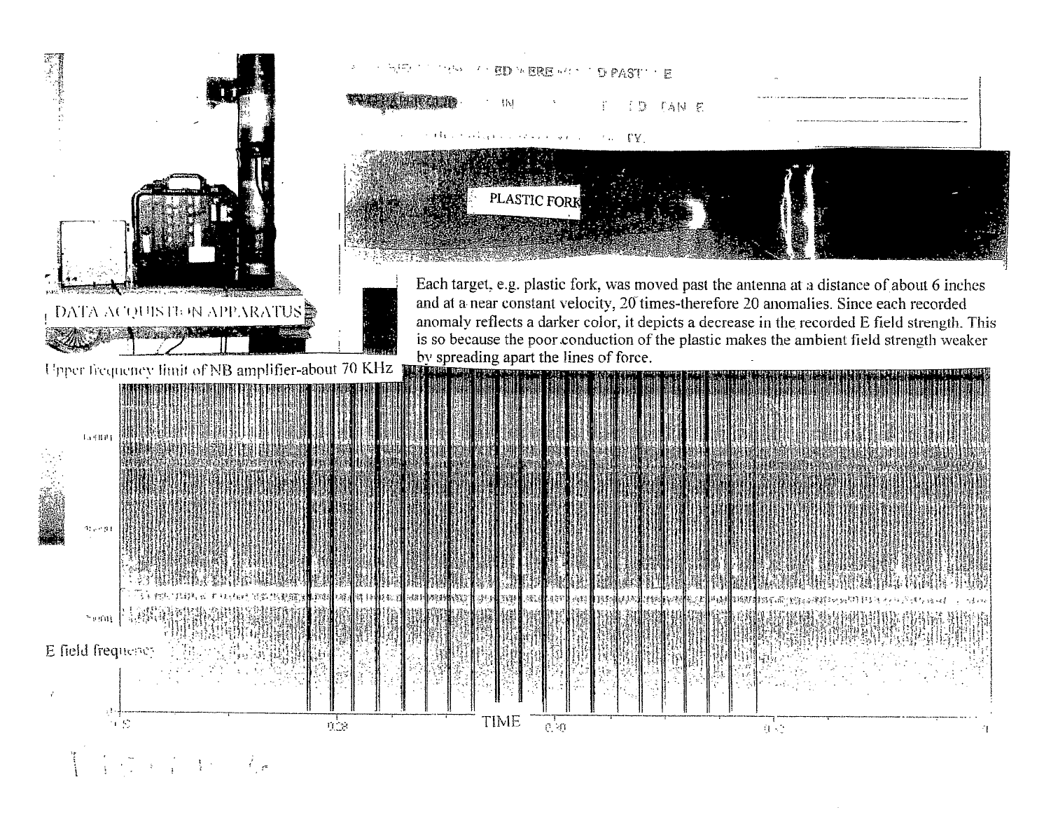

FIG. 6 depicts an alternative detection and recording apparatus where the reference number 110 generally refers to the detector unit. Signals are received at an antenna 112. The antenna may advantageously be a diepole antenna of the type described in Antennas and Transmission Lines by John A. Kueken, 1^{st} ed., 1969.

The output of the antenna is amplified by a high-impedance broad band preamplifier 114. The preamplifier may be of the type described in Application Manual For Operational Amplifiers, Philbric/Nexus Research, Nimrod Press, 1968.

The output from the preamplifier is filtered into “n” bands by “n” band pass filters 116. The band pass filters may be of the type described in Application Manual

For Operation Amplifiers (supra), see circuit illustration designated III.27. Preferably, the frequency bands are selected for sensitivity to the particular plastic materials of interest. For higher resolution, the band may be narrowed to as small as a fraction of a HZ (i.e., 0.1 to 1 HZ) at extremely low frequencies to slightly larger bands (i.e., 1 to 10 HZ) at intermediate frequencies and to even higher bands (i.e., 10-100 HZ) at relatively high frequencies. The signals monitored in different frequency bands yield information useful for different purposes.

The frequency information can be passed directly to the adder 124 or may be fed to a rectifying circuit, 118, which outputs a signal indicative of the mean amplitude of the signal in each frequency band over a time period. A typical rectifier may be of the type described in Electronics Designers Handbook, 2^{nd} Ed. revised, L. J. Giacoletto, McGraw Hill, 1977, Sec. 12.4.

For simple determination of the presence of plastic materials, the signals for each frequency band are passed directly to the adder 124.

The combined signal from the adder is passed through a comparator 126 to a spectral analyzer 154 and to a recording or display device 24. Alternatively, the signal from the amplifier 114 can pass directly through a broad band amplifier 30 to a recording device 60, where it is stored for later analysis.

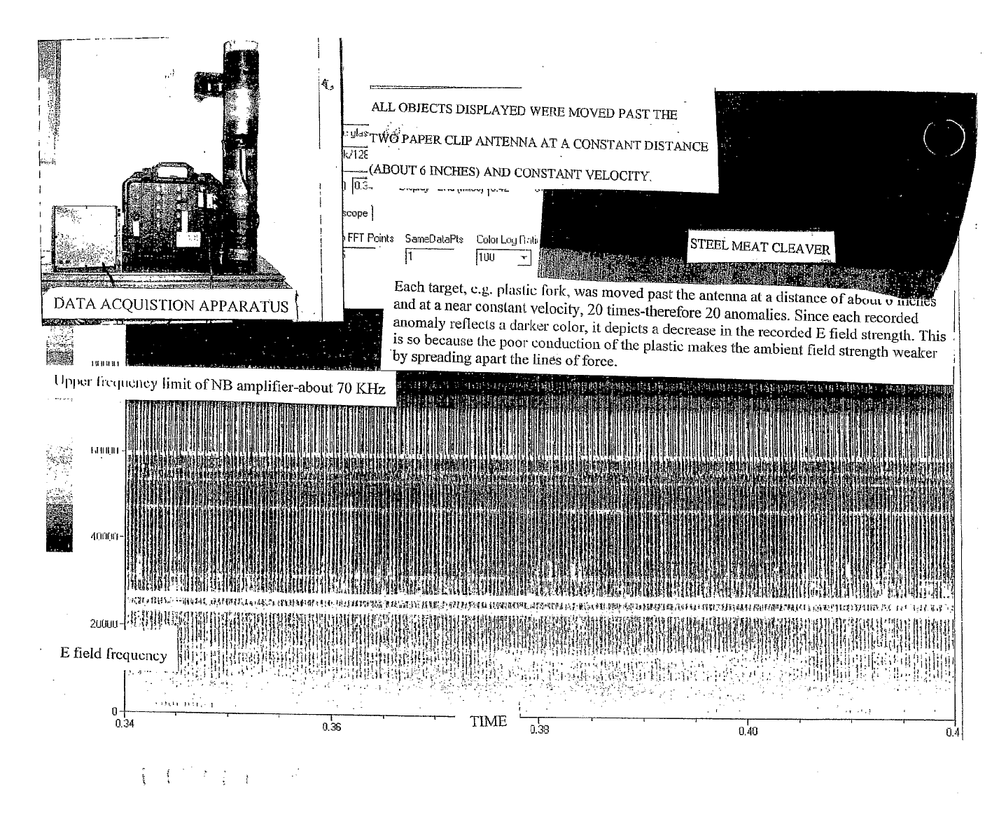

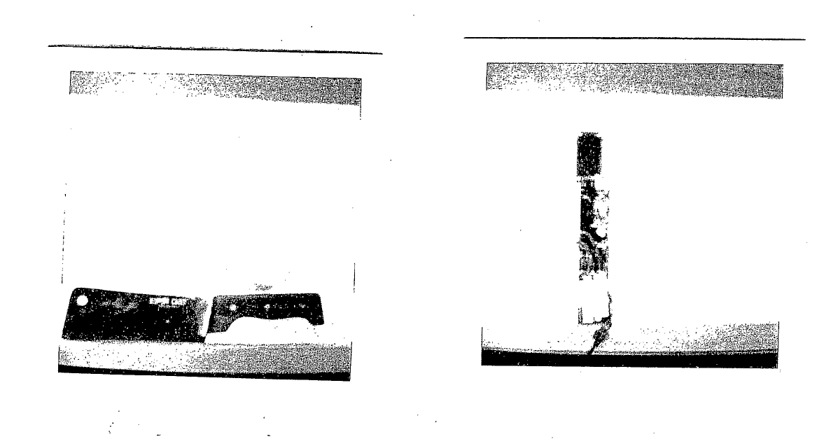

Numerous experiments were preformed by the inventor, by either moving the field relative to the target (wanding) or by moving the target into the field. The key is the movement of the target in the field so as to create changes in the gauge readings that indicate the presence of particular materials, the amount thereof, and the location thereof, thus enabling detection of various materials. Results of some of these experiments are shown in various figures. FIG. 6 depicts the result of moving a plastic fork, shown in more detail in FIG. 8, ten times through the field where each movement is shown as a darker line in the field frequency, thus confirming the detection of the movement of the plastic material in the field. Using the same apparatus, a steel meat cleaver as shown in FIG. 8 was moved through the field in the same manner for ten times. As shown in FIG. 7, no change in the field strength was noted, thus confirming the specificity for detection of plastic materials.

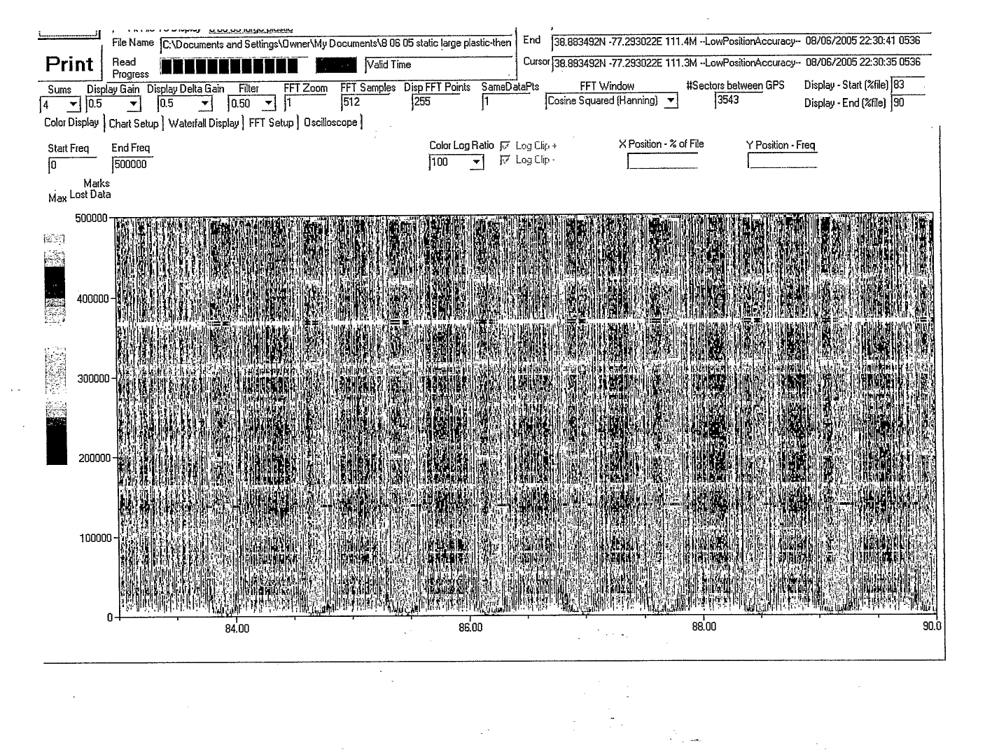

A suitable antenna, with an amplifier, is shown in FIG. 9.

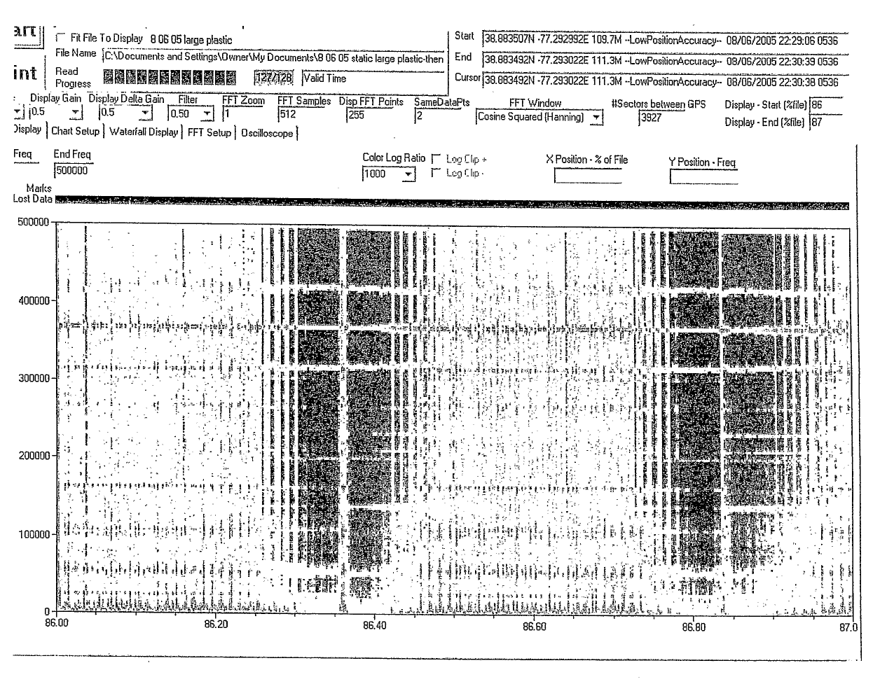

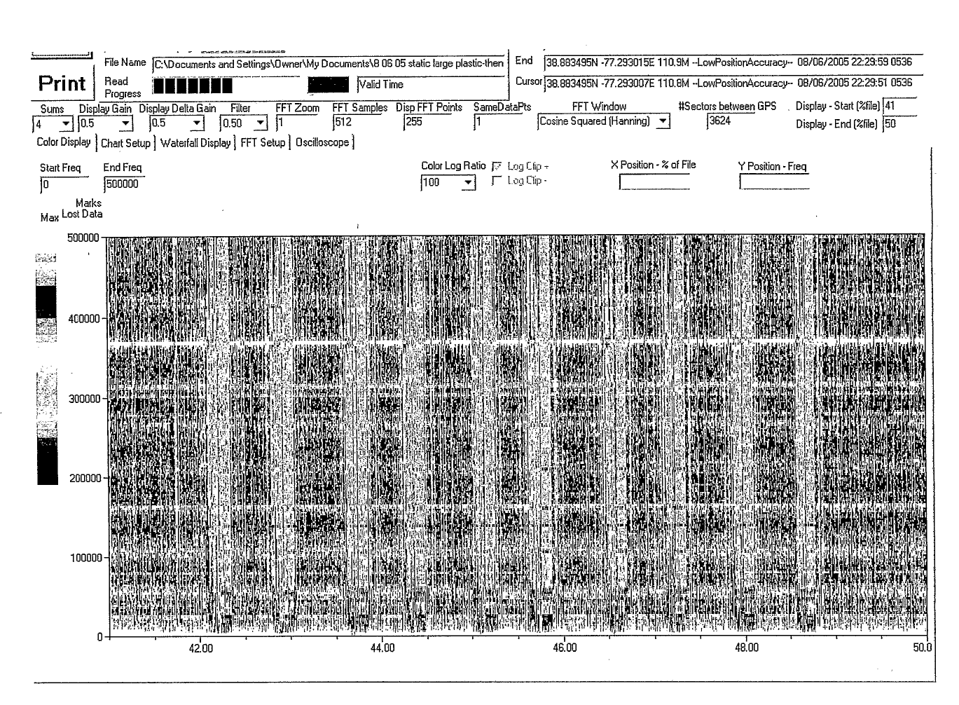

Detection of other plastic materials is shown in FIGS. 10-12, where the lines shown a variation in the field strength corresponding with the movement of the plastic material through the field.

From these experiments, it was clear that the apparatus of the present invention selectively detected the presence of plastic materials.

The foregoing description of a preferred embodiment of the invention has been presented for purposes of illustration and description. It is not intended to be exhaustive or to limit the invention to the precise form disclosed and, obviously, many modifications and variations are possible in light of the above teaching. The embodiment was chosen and described in order to best explain the principals of the invention and its practical application to thereby enable others skilled in the art to best utilize the invention in various embodiments and with various modifications as are suited to the particular use contemplated. It is intended that the scope of the invention be defined by the claims appended hereto.

I claim:

1. An apparatus for the detection of a plastic material in a target, said apparatus comprising:
at least one non-directional antenna;
a high-impedance input broadband receiver;
an anti-alias filter; and
an analog to digital converter.

2. The apparatus of claim 1 wherein the broadband receiver (1 to 50,000 HZ).

3. The apparatus of claim 1 further comprising means for processing the broadband signal.

4. The apparatus of claim 3, further comprising a monitoring or alarm system to indicated the presence of detected plastic material.

5. The apparatus of claim 4, wherein the presence of the plastic material is depicted in three dimensions.

6. The apparatus of claim 1, wherein the apparatus is in the form of a scanning wand to be run over the surface of the target.

7. The apparatus of claim 1, wherein the apparatus is in the form of a stationary unit through which the target is conveyed.

8. A method for the detection of a plastic material, said method comprising the steps of:
creating a field;
moving the target relative to the field;
noting changes in the field; and
correlating changes in the field to the presence of plastic materials.

9. The method of claim 8 wherein the target is moved through said field.

10. The method of claim 8 wherein said field is moved across the surface of said target.
